(19) United States
(12) Patent Application Publication
(10) Pub. No.: US 2009/0257377 A1
(43) Pub. Date: Oct. 15, 2009

(54) REDUCING BUFFER SIZE FOR REPEAT TRANSMISSION PROTOCOLS

(75) Inventors: Ramanuja Vedantham, Dallas, TX (US); Ariton E. Xhafa, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/419,498

(22) Filed: Apr. 7, 2009

Related U.S. Application Data
(60) Provisional application No. 61/043,477, filed on Apr. 9, 2008.

(51) Int. Cl. H04W 88/02

(52) U.S. Cl. 370/328

(57) ABSTRACT

A wireless communication device includes a receive buffer and control logic coupled to the receive buffer. The control logic implements an algorithm to selectively drop data blocks in the receive buffer once a predetermined fill threshold for the receive buffer is reached. The receive buffer is sized so that a drop activity level for the algorithm is within a predetermined range.

### CROSS-REFERENCE TO RELATED APPLICATIONS

The present application claims priority to U.S. provisional patent application Ser. No. 61/043,477, filed Apr. 9, 2008, and entitled “Method for Improving Receive Buffer Requirements of Window-Based ARQ Protocols in Wireless Networks” hereby incorporated herein by reference.

### BACKGROUND

With the proliferation of modern wireless technologies, networked devices have become nearly ubiquitous. Networked devices often employ a multi-layered protocol architecture to simplify communications. The layers serve to isolate each function to a particular hierarchical system, thereby isolating other systems within the protocol hierarchy from the details of functionalities implemented in disparate layers.

Network protocol layering is often based on the Open Systems Interconnection Model (“OSI”), as specified in ITU-T Recommendation X.200. The OSI model specifies seven protocol layers traversed by data as it passes between the transmission media and the relevant application. Each layer may copy the data received from the previous layer, and pass a modified version of the data to the subsequent layer for further processing.

The first and lowest layer of a protocol stack is often termed the “physical” layer. The physical layer provides the network device with means to access the physical media interconnecting devices, and to transmit and receive bit streams via that media.

The data link layer resides atop, and is serviced by, the physical layer of the network stack. The data link layer may provide a variety of services to higher levels, and therefore comprise a number of functionalities. Representative data link layer functionalities include error correction by automatic retransmission request, ciphering and deciphering of data units, and segmentation and reassembly of data units. The data link layer may be further sub-divided into a number of sub-layers to implement the required functionalities. Each sub-layer receives data from the previous sub-layer, processes the data, and passes the processed data to the next sub-layer for further processing. Sub-layer processing may include copying, as well as other manipulations of the data.

Many wireless networking protocols include MAC-level automatic repeat request (ARQ) protocols to control re-transmissions in the presence of channel errors. A window-based ARQ protocol improves efficiency by using a single feedback message to acknowledge multiple transmitted packets. The ‘window’ defines the number of transmitted-but-not-acknowledged blocks. Thus, a window size of 512 means that the transmitter can send up to 512 packets, prior to which a feedback must be received.

Wide-area wireless standards like 3GPP EUTRA (LTE) and WiMAX use window-based ARQ protocols exclusively to increase performance over the long-latency links. In LTE, the layer 2 protocol stack is divided into 3-sublayers: the PDCP sub-layer, RLC sub-layer and the MAC sub-layer. On the transmit side, the PDCP layer performs protocol convergence from IP packet format to RAN (radio access network) format, and performs encryption and robust header compression during normal operation. The RLC sub-layer is responsible for concatenation and segmentation of PDCP packets (PDCP PDUs) based on a MAC allocation and optionally an ARQ (AM mode) operation, also known as radio bearer or LCID in LTE. The MAC layer also multiplexes all the RLC packets (RLC PDUs) into a single packet called a transport block (TB) for transmission over air interface. Thus, the ARQ protocol (AM mode operation as is called in the standard) operates on top of MAC-level HARQ retransmissions which are performed at the transport block level. On the receive side, the exact opposite functions are performed with the MAC layer performing de-multiplexing to acquire the individual RLC PDUs belonging to different LCIDs, the RLC layer performing in-sequence delivery to PDCP (reordering and reassembly), and the PDCP layer performing decryption and header de-compression. An important consideration in the design of ARQ operation (AM mode) (or other repeat transmission techniques) is the amount of memory required to buffer out-of-sequence packets (e.g., RLC PDUs) in the receiver.

### SUMMARY

In at least some embodiments, a wireless communication device comprises a receive buffer and control logic coupled to the receive buffer. The control logic implements an algorithm to selectively drop data blocks in the receive buffer once a predetermined fill threshold for the receive buffer is reached. The receive buffer is sized so that a drop activity level for the algorithm is within a predetermined range.

In at least some embodiments, a receiver comprises a Radio Link Control (RLC) reordering buffer and control logic coupled to the RLC reordering buffer. The control logic artificially increases a data error rate by selectively dropping good content from the RLC reordering buffer based on a predetermined fullness level of the RCL reordering buffer. The receive buffer is sized to maintain the error rate within a predetermined range.

In at least some embodiments, a method comprises receiving a plurality of data flows and storing good data flows in a receive buffer. If a near-max fill threshold for the receive buffer is reached, the method selectively drops good data flows from the receive buffer. During the method, the receive buffer is sized to maintain the selective dropping within a predetermined drop range.

### BRIEF DESCRIPTION OF THE DRAWINGS

For a detailed description of exemplary embodiments of the invention, reference will now be made to the accompanying drawings in which:

FIG. 1 shows a wireless network in accordance an embodiment of the disclosure;

FIG. 2 shows a protocol stack and sub-layers of the data link layer of the protocol stack in accordance with an embodiment of the disclosure;

FIG. 3 shows a communication system in accordance with an embodiment of the disclosure;

FIG. 4 shows a method in accordance with an embodiment of the disclosure;

FIG. 5 shows a simulation-based chart that estimates buffer overflow probability versus buffer size in accordance with an embodiment of the disclosure; and

FIG. 6 shows an analysis-based chart that estimates buffer overflow probability versus buffer size in accordance with an embodiment of the disclosure.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more hardware and/or software components, and may be used to refer to an electronic device or devices, or a sub-system thereof.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment. While embodiments of the present disclosure are described primarily in the context of wireless communication systems, those skilled in the art will recognize that embodiments are applicable to data link layer protocols in a variety of communication and networking systems employing wire, optical and other transmission media. The present disclosure encompasses all such embodiments.

Embodiments of the disclosure are directed to wireless communication devices that implement repeat transmission protocols such as automatic repeat request (ARQ) protocols. In at least some embodiments, a wireless communication device comprises a receive buffer and control logic coupled to the receive buffer. The control logic implements an algorithm to selectively drop data blocks in the receive buffer once a predetermined fill threshold for the receive buffer is reached. The receive buffer is sized so that a drop activity level for the algorithm is within a predetermined range. The disclosed receive buffer and control logic may be implemented for downlink and uplink scenarios (i.e., the transmitter-receiver can be either base station (BS)-user equipment (UE) or UE-BS).

In accordance with LTE embodiments, the receive buffer corresponds to a reordering buffer. This reordering buffer may be sized on a per-LCID (local channel identifier) basis with the peak size of the reordering buffer being dependent on the time allowed for hybrid ARQ (HARQ) level retransmissions to be successful before issuance of a RLC (radio link control)-level negative acknowledgement for the missing packet. Thus, the peak reordering buffer requirement for each LCID is dependent on the “HARQ reordering timer” as well as the number of out-of-sequence PDUs (protocol data units) received within this HARQ reordering timer, which depends on the data rate for the LCID. After the HARQ reordering timer expires, in the AM mode of operation, a feedback message is sent by a receiving device to the transmitting device to transmit the missing PDUs. After the missing PDUs have been received successfully at the receiver, the RLC PDUs are delivered in-order to the PDCP (data packet convergence protocol) layer. Thus, the peak reordering buffer for each LCID is dependent on the HARQ reordering time and the time for retransmissions to be received successfully.

In order to determine the size of the reordering buffer for each LCID appropriately, various parameters are considered. In accordance with at least some embodiments, the reordering buffer should be sized to handle the peak reordering buffering requirements for a typical scenario (e.g., a few LCIDs operating at high-data rates with random errors), but should not be sized to handle the peak buffering requirements for a worst-case scenario (e.g., many LCIDs operating at high-data rates with simultaneous errors). Sizing the reordering buffer in this manner reduces the price of the receiver chip without significantly increasing the receiver error rate for typical scenarios. In accordance with embodiments, the size of the reordering buffer is selected to maintain a drop activity level of the reordering buffer (i.e., a perceived error rate) within a predetermined range (e.g., 3-5%) for the typical scenario. The drop activity level is controlled, for example, based on an algorithm that determines when to drop data blocks and which data blocks to drop. For example, a predetermined fill threshold may determine when data blocks are selectively dropped from the reordering buffer and a prioritization scheme (e.g., based on Quality of Service (QoS) requirements for each call) may determine which data blocks are dropped once the predetermined fill threshold has been reached. Additional details are provided hereafter.

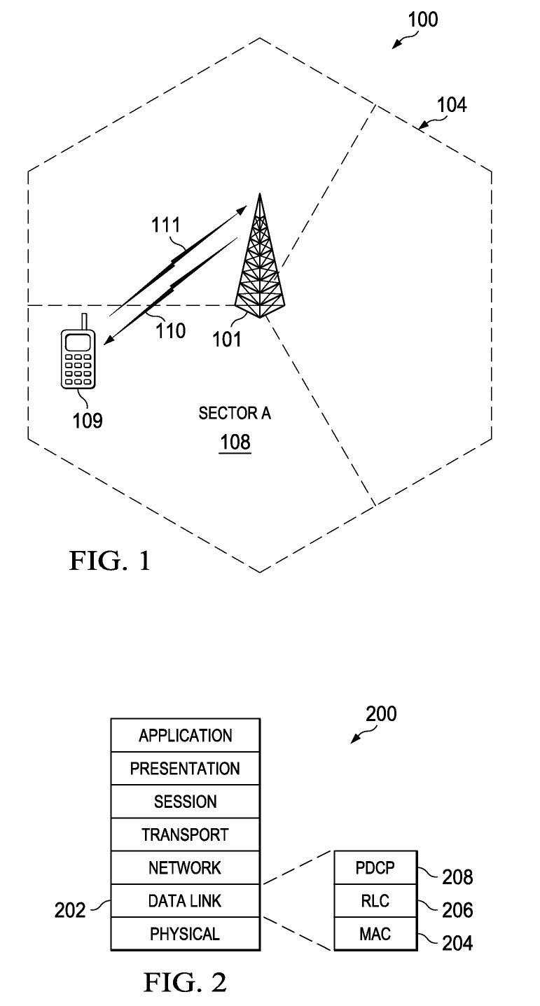

FIG. 1 shows a wireless network 100 in accordance an embodiment of the disclosure. As shown, the wireless network 100 includes base station 101, though in practice, a wireless telecommunications network may include more base stations than illustrated. A base station may also be known as a fixed access point, a Node B, an e-Node B, etc. Base station 101 is operable over cell 104. The cell 104 is further divided into sectors. In the illustrated network, the cell 104 is divided into three sectors. Cellular telephone or other user equipment (“UE”) 109 is shown in sector A 108, which is within cell 104. Though as a matter of simplicity only a single UE is shown, in practice system 100 may include any number of UEs. The UE 109 may also be called a mobile terminal, a mobile station, etc. Base station 101 transmits to UE 109 via down-link 110, and receives transmissions from UE 109 via up-link 111.

Message transfer between base station 101 and UE 109 is facilitated by multi-layer protocol stacks. Generally, each layer and/or sub-layer of a transmitter protocol stack adds a header to the data unit being passed to the next lower layer or sub-layer. The headers include fields identifying the operations performed at that protocol layer. Each layer or sub-layer of a receiver protocol stack parses the header inserted in the corresponding transmission layer to allow reconstruction of a data unit provided to the next higher layer or sub-layer. As disclosed herein, either or both the base station 101 and the UE 109 implement a receive buffer and a control algorithm for use with ARQ or HARQ protocols. For example, the receive buffer and control algorithm may be part of a RLC sub-layer of a data link layer. In accordance with embodiments, the control algorithm selectively drops data blocks in the receive buffer once a predetermined fill threshold for the receive buffer is reached. Also, the receive buffer is sized so that a drop activity level for the control algorithm is within a predetermined range.

FIG. 2 shows an illustrative seven layer protocol stack 200. The various layers of the stack may be further divided in sub-layers. As illustrated, the data link layer 202 of the exemplary protocol stack may be further sub-divided into multiple sub-layers as prescribed by, for example, the Long Term Evolution (“LTE”) wireless telecommunication standard of the Third Generation Partnership Project (“3GPP”). In FIG. 2, the data link layer 202 comprises a Media Access Control (“MAC”) sub-layer 204, a Radio Link Control (“RLC”) sub-layer 206, and a Packet Data Convergence Protocol (“PDCP”) sub-layer 208. Note that the data link layer 202 may comprise various other sub-layers not illustrated here.

Servicing the protocol stack layers, for example, the data link layer 202 requires a substantial amount of data packet manipulation and intensive bit level data processing. The above-mentioned sub-layers of the data link layer may, for example, add/remove headers, encrypt/decrypt payloads, segment/reassemble data blocks, concatenate data units, pad data units, compress/decompress headers, etc. The performance of these operations may be communicated through headers constructed at the various sub-layers of the data link layer 202. In accordance with some embodiments, the discussed operations may be used, for example, to implement ARQ or HARQ protocols. For example, using these operations, a UE device may notify a base station regarding which data blocks should be retransmitted due to the artificial error rate caused by sizing the UE's receive buffer to maintain a predetermined error rate.

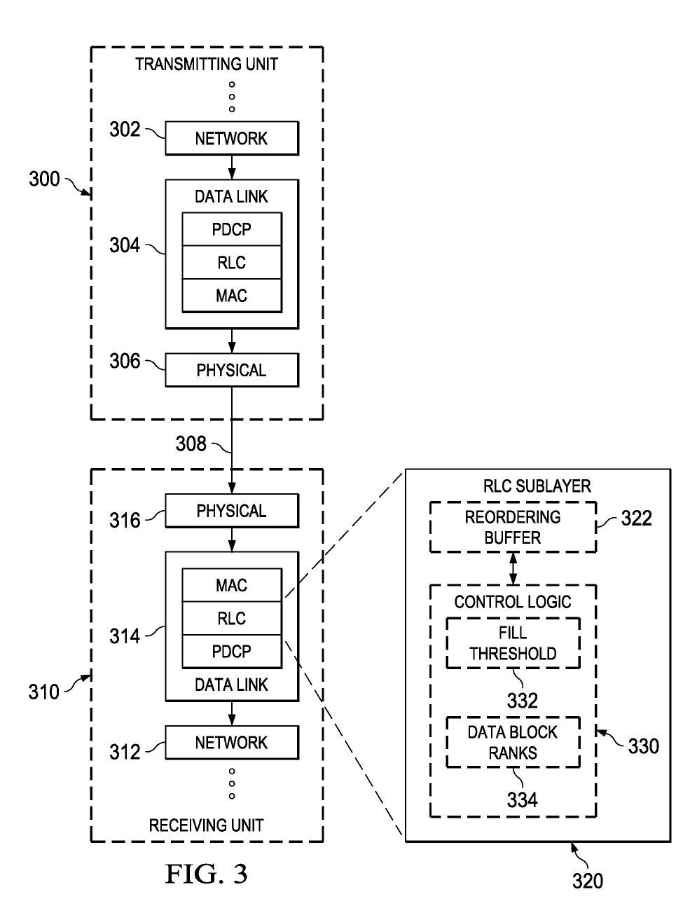

FIG. 3 shows an illustrative transfer between wireless devices including protocol stacks in accordance with embodiments of the invention. A message originates in the network layer 302 (layer 3), or possibly a layer above the network layer 302 of transmitting unit 300. The message is passed down to layer 2, the data link layer 304, for processing in the various sub-layers. For example, PCDP sub-layer processing may comprise internet protocol (“IP”) header compression and/or data encryption and/or addition of PDCP headers. RLC sub-layer processing may comprise segmentation, the decomposition of the PCDP data unit into multiple RLC data units when the PDCP data unit is larger than the RLC data unit, and the addition of RLC headers. MAC sub-layer processing may comprise assembling multiple RLC data units into a larger MAC data unit, prefixing a header to the data unit, and encrypting the data. MAC sub-layer data units are delivered to the physical layer 306 for transmission via media 308 to the receiving unit 310. For more information regarding data link layer headers for use with an ARQ or HARQ protocol, reference may be made to had to application Ser. No. 12/140,012 filed Jun. 16, 2008 and entitled “Data Link Layer Headers”, which is hereby incorporated herein by reference.

The protocol stack of receiving unit 310 reverses the processing applied in the protocol stack of transmitting unit 300 to reconstruct the message passed from network layer 302 to the data link layer of transmitting unit 300. Reversal of the processing applied in the transmitting unit 300 protocol stack is enabled by the headers prefixed to the data unit at each layer/sub-layer. Error correction techniques may also be applied in the sub-layers of the data link layer 314 to ensure error free delivery of data units. Further, the RLC sub-layer of the data link layer 314 may comprise a reordering buffer 322 and control logic 330 coupled to the reordering buffer 322. The control logic 330 controls the content of the reordering buffer 322 based on a fill threshold 332 and data block ranks 334.

In accordance with at least some embodiments, the fill threshold may be reached, for example, when approximately 90% (perhaps between 80% to 95%) of the reordering buffer 322 is filled. Once the fill threshold has been reached, the lowest ranked data blocks that are stored (or that are soon to be stored) in the reordering buffer 322 will be dropped. The control logic 330 assigns the data block ranks 334, for example, based on a quality of service (QoS) requirements for each data block. If the lowest ranked data blocks comprise more than a threshold amount of space (e.g., 20% or more) in the reordering buffer 322, the control logic 330 may drop some but not all the lowest ranked data blocks once the predetermined fill threshold has been reached. Preferably, the drop activity level of the reordering buffer 322 is intentionally maintained within a predetermined range (e.g., 2-5% of received data blocks in a typical scenario). Maintaining the drop activity level in the predetermined range is intended to artificially increase the data error rate by a small amount in exchange for a significant reduction in the size of the reordering buffer 322 (e.g., a 20-50% reduction).

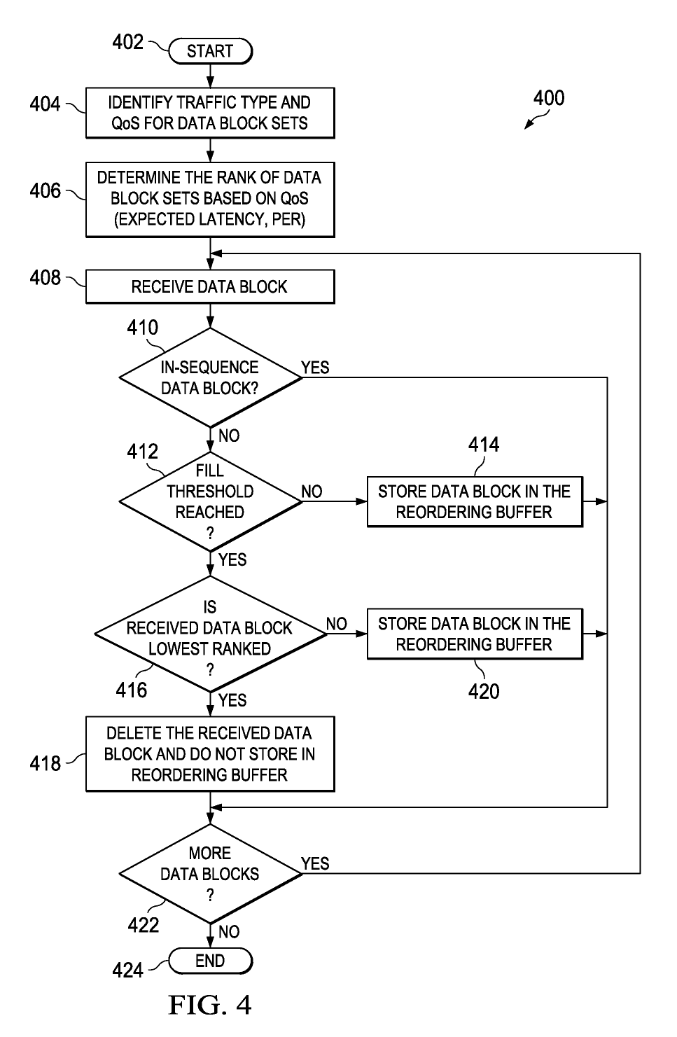

FIG. 4 shows a method 400 in accordance with an embodiment of the disclosure. After the method 400 starts at block 402 (e.g., after initial connection setup for all transport blocks or after a new transport block has been added), the traffic type and QoS requirements for each data block set (e.g., each transport block) is identified (block 404). Data block sets are then ranked based on the traffic type and QoS requirements (block 406). Examples of QoS requirements include expected latency and expected packet error rate (PER) requirements. Upon receiving a data block (e.g., a data PDU) at block 408), a determination is made regarding whether the data block is in sequence (decision block 410). If the received data block is in sequence (decision block 410), the method 400 determines if there are any more data blocks (decision block 422). If there are more data blocks (decision block 422), the method 400 returns to block 408. If there are no more data blocks (decision block 422), the method 400 ends at block 424.

If the received data block is not in sequence (decision block 410), a determination is made regarding whether the fill threshold of the reordering buffer has been reached (decision block 412). If the fill threshold has not been reached (decision block 412), the received data block is stored in the reordering buffer (block 414) and the method proceeds to decision block 422. If the fill threshold has been reached (decision block 412), a determination is made regarding whether the received data block is the lowest ranked data block (decision block 416). If so, the received data block is deleted or is otherwise not stored in the reordering buffer (block 418) and the method proceeds to decision block 422. If the received data block is not the lowest ranked data block (decision block 416), the received data block is stored in the reordering buffer (block 420) and the method proceed to decision block 422. If necessary, lower ranked data block are deleted from the reordering buffer to make space for incoming data blocks.

As an example of the method 400, when a RLC PDU arrives, the LCID corresponding to the RLC PDU is determined. If the received RLC PCU is the expected in-sequence packet, it is forwarded to the reordering buffer where PDCP PDUs are reassembled and sent to the PDCP layer. If the received RLC PDU is out-of-sequence, it is buffered in the reordering buffer as long as the overall fill threshold has not been reached. The fill threshold is representative of the percentage of the overall buffer space after which selective dropping is enforced (e.g., after 95% full, selective dropping is enforced). If the fill threshold has been reached, the rank of the LCID corresponding to the RLC PDU is determined. If the LCID corresponding to the RLC PDU is the lowest rank (there can be multiple LCIDs that are mapped to the lowest rank depending on the QoS requirements), the received RLC PDU is dropped to avoid filling up the RX buffer. The feedback message generated subsequently will reflect that the RLC PDU was unsuccessfully received and a retransmission of the RLC PDU will occur. If on the other hand, the received RLC PDU does not correspond to the lowest rank LCID, the received RLC PDU is stored in the reordering buffer. By artificially increasing error rate by a small amount, the overall buffer size is reduced.

More generally, the disclosed receive method involves receiving a plurality of data flows and storing good data flows in a receive buffer. If a near-max fill threshold for the receive buffer is reached, good data flows are selectively dropped from the receive buffer, where the receive buffer is sized to maintain the selective dropping within a predetermined drop range. In accordance with embodiments, ranks are assigned to each good data flow and the lowest ranked good data flows are dropped from the receive buffer if the near-max fill threshold is reached. If the lowest ranked data flows account for more than a threshold amount of space in the receive buffer, some but not all of the lowest ranked data flows are dropped if the near-max fill threshold is reached. The receive method also tracks the good data flows that are dropped and requests retransmission of these dropped good data flows. The disclosed receive method applies when good data flows are received out of order and thus storage in the reordering buffer occurs.

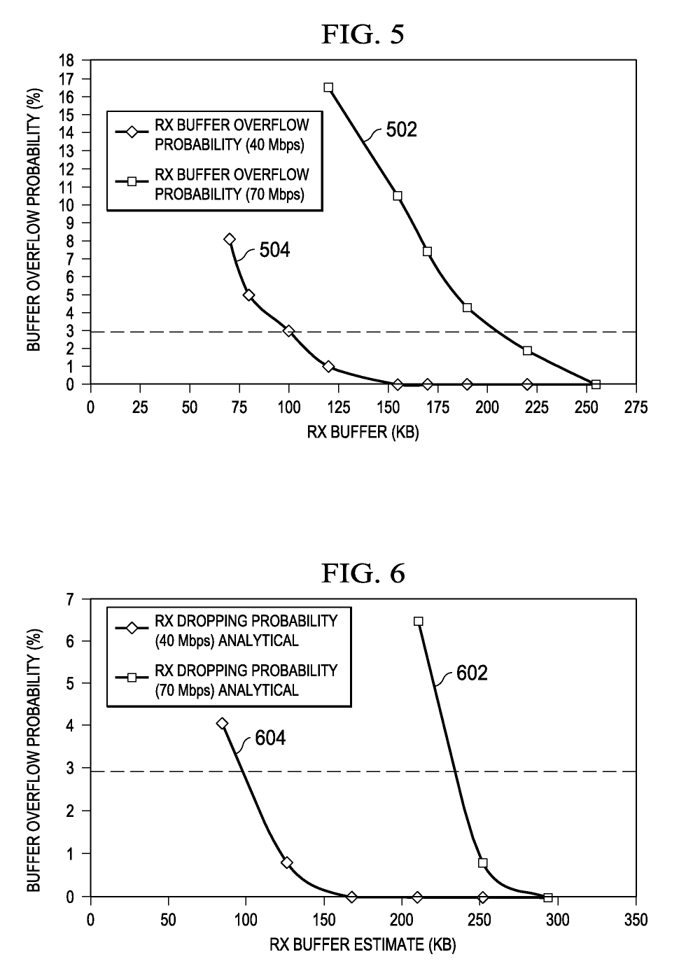

FIG. 5 shows a chart 500 that estimates buffer overflow probability versus buffer size in accordance with an embodiment of the disclosure. The chart 500 was generated using OPNET (Optimized Network Evaluation Tool) simulations. In the chart 500, a first receive (RX) buffer overflow probability 502 corresponds to a data rate of 70 Mbps and a second RX buffer overflow probability 504 corresponds to a data rate of 40 Mbps. To maintain the RX buffer overflow probability 502 around 0%, the RX buffer has a size of approximately 255 KB. As the RX buffer overflow probability 502 increases from 0% to about 16%, the size of the RX buffer decreases from approximately 255 KB to about 125 KB. In at least some embodiments, the size of the RX buffer is selected so that RX buffer overflow probability 502 is at approximately 3%. In such case, the size of the RX buffer would be reduced from approximately 255 B KB to about 210 KB (a reduction of 18% or so). Meanwhile, to maintain the RX buffer overflow probability 504 around 0%, the RX buffer has a size of approximately 155 KB. As the RX buffer overflow probability 504 increases from 0% to about 8%, the size of the RX buffer decreases from approximately 155 KB to about 70 KB. In at least some embodiments, the size of the RX buffer is selected so that RX buffer overflow probability 504 is at approximately 3%. In such case, the size of the RX buffer would be reduced from approximately 155 B KB to 100 KB (a reduction of 36% or so). In alternative embodiments, the size of the RX buffer could be selected so that the RX buffer overflow probability 504 is more or less than 3% (e.g., between 2% and 10%).

In some embodiments, the maximum RX buffer requirement occurs when all 3 retransmissions of a HARQ transport block have not been received correctly and the out-of-sequence RLC PDUs received subsequently need to be buffered. Thus, the maximum RX buffer for a particular LCID is dependent on the HARQ reordering timer value (the timer value corresponding to at least three HARQ retransmissions of a missing transport block).

FIG. 6 shows another chart 600 that estimates buffer overflow probability versus buffer size in accordance with an embodiment of the disclosure. The chart 600 is based on analytical calculations. In the chart 600, a first receive (RX) buffer overflow probability 602 corresponds to a data rate of 70 Mbps and a second RX buffer overflow probability 604 corresponds to a data rate of 40 Mbps. To maintain the RX buffer overflow probability 602 around 0%, the RX buffer has a size of approximately 290 KB. As the RX buffer overflow probability 602 increases from 0% to about 6.5%, the size of the RX buffer decreases from approximately 290 KB to about 210 KB. In at least some embodiments, the size of the RX buffer is selected so that RX buffer overflow probability 602 is at approximately 3%. In such case, the size of the RX buffer would be reduced from approximately 290 B KB to about 230 KB (a reduction of 20% or so). Meanwhile, to maintain the RX buffer overflow probability 604 around 0%, the RX buffer has a size of approximately 168 KB. As the RX buffer overflow probability 604 increases from 0% to about 4%, the size of the RX buffer decreases from approximately 168 KB to about 70 KB. In at least some embodiments, the size of the RX buffer is selected so that RX buffer overflow probability 604 is at approximately 3%. In such case, the size of the RX buffer would be reduced from approximately 168 B KB to about 95 KB (a reduction of 44% or so). In alternative embodiments, the size of the RX buffer could be selected so that the RX buffer overflow probability 604 is more or less than 3% (e.g., between 2% and 10%).

The chart 600 is based on various computations and assumptions as will now be discussed in greater detail. Consider a scenario where application traffic of 40 Mbps is composed of four radio bearers, each with an application rate of 10 Mbps (content download traffic), and application traffic of 70 Mbps is composed of 7 such radio bearers. For the 40 Mbps application rate scenario, the Maximum RX buffer per LCID in AM mode=(HARQ reordering timer+RLC status round-trip time)*PDCP PDU size/(arrival time)=(26+8)*1500/1.2=42 KB. In such case, the Peak RX buffer requirement for 40 Mbps application traffic=168 KB. This peak RX buffer requirement happens only when the transport block that resulted in the HARQ reorder timer expiry carried RLC PDUs belonging to all four LCIDs. The probability for multiple LCIDs present in a transport block can be estimated by letting ‘n1’ represent the total number of RBIDs/LCIDs and letting ‘n2’ represent the number of LCIDs that have the peak application traffic rate of 10 Mbps. These traffic application types will typically have an inter-arrival time of about 1 ms and so there is a PDU arriving every TTI (transmission time interval) for each of these LCIDs. Consequently, for all ‘n2’ LCIDs, there will be at least 1 outstanding PDU that needs to be transmitted for any given TTI with a high probability (a probability of 1 is assumed). The probability that ‘n2’ PDUs in a transport block are all from the peak application traffic class may be calculated as ‘n2’ PDUs are from peak application traffic=1/(ⁿ¹Cₙ₂)=n2!(n1−n2)!/n1!. For the scenario under consideration n1=n2, and so this probability is 1. The probability of exceeding a certain RX buffer limit is calculated by just considering the probability that there are at least ‘k’ LCIDs out of a total of ‘n2’ that belong to peak application traffic in the missing transport block (TB). Thus, the buffer overflow probability for an RX buffer of at least 126 KB=the probability of at least 4 LCIDs of peak application traffic in the missing TB*probability of the all HARQ retransmissions failing=1*(0.3)⁴=0.81%. The buffer overflow probability for an RX buffer of 84 KB=combinations where at least 3 LCIDs of peak traffic are in a TB*the probability of all HARQ retransmissions failing=(⁴C₃+1)*(0.3)⁴=5*0.81=4.05%. If linear interpolation between the two data points is assumed, the RX buffer size where the buffer overflow probability is 3% is approximately 95 KB.

For the 70 Mbps application rate scenario, consider 7 LCIDs with a peak application rate of 10 Mbps. It is assumed that the maximum RX buffer per LCID=42 KB (the same as before) and the peak RX buffer requirement for 70 Mbps application=294 KB. This peak requirement happens only when the TB that resulted in the HARQ reorder timer expiry carried RLC PDUs belonging to all seven LCIDs. The probability that all ‘n2’ PDUs are from peak application traffic out of a total of ‘n1’ LCIDs=1/(ⁿ¹Cₙ₂)=n2!(n1−n2)!/n1!. For the scenario under consideration n1=n2 and so this probability is 1. The probability of exceeding a certain RX buffer limit is calculated by just considering the probability that there are at least ‘k’ LCIDs out of a total of ‘n2’ that belong to peak application traffic in the missing TB. Thus, the buffer overflow probability for an RX buffer of at least 252 KB=the probability of at least 7 LCIDs of peak application traffic in the missing TB*probability of the all HARQ retransmissions failing=1*(0.3)⁴=0.81%. The buffer overflow probability for an RX buffer at least 210 KB=combinations where at least 6 LCIDs of peak traffic are in a TB*the probability of all HARQ retransmissions failing=(⁷C₆+1)*(0.3)⁴=8*0.81=6.48%. If linear interpolation between the two data points is assumed, the RX buffer size where the buffer overflow probability is 3% is approximately 230 KB. The results of OPNET simulations as described for FIG. 5 and analytical calculations as described for FIG. 6 coincide and demonstrate that the receive buffer size can be significantly reduced without significantly increasing the receiver error rate.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A wireless communication device, comprising:
a receive buffer; and
control logic coupled to the receive buffer, wherein the control logic implements an algorithm to selectively drop data blocks in the receive buffer once a predetermined fill threshold for the receive buffer is reached,
wherein the receive buffer is sized so that a drop activity level for the algorithm is within a predetermined range.

2. The wireless communication device of claim 1 wherein the control logic assigns a rank to each received data block and selectively drops data blocks in the receive buffer based on said ranks.

3. The wireless communication device of claim 2 wherein said ranks are based on quality of service (QoS) requirements for each data block.

4. The wireless communication device of claim 2 wherein if lowest rank data blocks comprise more than a threshold amount of space in the receive buffer, the control logic drops some but not all lowest rank data blocks once a predetermined fill threshold for the receive buffer is reached.

5. The wireless communication device of claim 1 wherein the control logic and the receive buffer are part of a Radio Link Control (RLC) layer.

6. The wireless communication device of claim 1 wherein the drop activity level is greater that 2% and less than 10% of received data blocks.

7. The wireless communication device of claim 1 wherein the predetermined fill threshold is within a range between 85% to 95% full.

8. The wireless communication device of claim 1 wherein the wireless communication device is a user equipment.

9. The wireless communication device of claim 1 wherein the wireless communication device is a base station.

10. A receiver, comprising:
a Radio Link Control (RLC) reordering buffer; and
control logic coupled to the RLC reordering buffer, wherein the control logic artificially increases a data error rate by selectively dropping good content from the RLC reordering buffer based on a predetermined fullness level of the RCL reordering buffer,
wherein the receive buffer is sized to maintain the error rate within a predetermined range.

11. The receiver of claim 10 wherein the control logic identifies, ranks, and stores good data blocks that are received and selectively drops good data blocks stored in the RCL reordering buffer based on said ranks.

12. The receiver of claim 11 wherein said ranks are based on quality of service (QoS) requirements identified for each data block.

13. The receiver of claim 10 wherein the error rate is maintained within a range of 2-5%.

14. The receiver of claim 10 wherein the predetermined fullness level is within a range between 85% to 95% full.

15. A method, comprising:
receiving a plurality of data flows;
storing good data flows in a receive buffer; and
if a near-max fill threshold for the receive buffer is reached, selectively dropping good data flows from the receive buffer,
wherein the receive buffer is sized to maintain said selective dropping within a predetermined drop range.

16. The method of claim 15 further comprising assigning a rank to each good data flow.

17. The method of claim 16 further comprising dropping lowest ranked good data flows from the receive buffer if the near-max fill threshold is reached.

18. The method of claim 17 further comprising determining if said lowest ranked data flows comprise more than a threshold amount of space in the receive buffer and, if so, dropping some but not all of said lowest ranked data flows if the near-max fill threshold is reached.

19. The method of claim 15 further comprising tracking dropped good data flows and requesting retransmission of said dropped good data flows.

20. (canceled)

21. The method of claim 15 further comprising selecting said predetermined drop range as approximately 2-4% of received data flows.
